(19) United States
(12) Patent Application Publication
(10) Pub. No.: US 2008/0163233 A1
(43) Pub. Date: Jul. 3, 2008

(54) Method and apparatus for service load consolidation, and computer product

(75) Inventor: Hiromichi Kobayashi, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/903,967

(22) Filed: Sep. 25, 2007

(30) Foreign Application Priority Data
Dec. 27, 2006 (JP) 2006-351100

(51) Int. Cl. G06F 9/50

(52) U.S. Cl. 718/104

(57) ABSTRACT

A load distribution rate is calculated among resources utilized in a service based on load information for each resource utilized in the service. If it is determined that loads of the service distributed to the resources are excessively distributed and that the loads are to be consolidated, a resource having the smallest load is detected from among the resources utilized in the service and the load of the detected resource is allocated to another resource to consolidate the service load.

### CROSS-REFERENCE TO RELATED APPLICATIONS

This application is based upon and claims the benefit of priority from the prior Japanese Patent Application No. 2006-351100, filed on Dec. 27, 2006, the entire contents of which are incorporated herein by reference.

### BACKGROUND OF THE INVENTION

1. Field of the Invention

The present invention relates to a technology for load consolidation among multiple processing resources.

2. Description of the Related Art

Conventionally, due to lack of flexibility, a large amount of additional investment can be required for increasing processing power. For example, since necessary peak power is elevated along with changes in a business situation, additional computation resources are necessitated. Conversely, although a large amount of reserve resources may be ensured to make an allowance for abrupt load increases, the resources are wasted in many cases.

Therefore, in a proposed technology according to Japanese Patent Application Laid-Open Publication No. H10-97435, a computation resource (hereinafter, “resource”) is allocated based on a prioritization of resource users, or the compliance of a resource user in response to a resource release request, and the resource is effectively shared.

In a proposed technology according to Japanese Patent Application Laid-Open Publication No. H05-120041, a low-priority service is shifted to a forced wait-state, and a resource allocated to the low-priority service is reallocated to a high-priority service to effectively utilize the resource.

However, in the above conventional technologies, while multiple resources are utilized for a service, if the task load of the service is reduced, the task load allocated to each resource is evenly reduced, and the task load of the service may be distributed among multiple resources.

That is, since no assumption has been made about how the task load allocated to each of the multiple resources is to be reduced as the overall task load of the service decreases, for example, a small task load is evenly allocated to each resource, and the task load of the service remains distributed among all the resources.

To switch the utilization of a resource from one service to another service, it is preferable to perform the switch after the active task has been completely terminated.

Therefore, if the task load of the service remains in all the resources, even if a resource is selected as the target of the switching, time is required for termination of the active task, resulting in a problem it takes time to provide another service.

### SUMMARY OF THE INVENTION

It is an object of the present invention to at least solve the above problems in the conventional technologies.

A computer-readable recording medium according to one aspect of the present invention stores therein a computer program that causes a computer to execute acquiring load information for each resource among a plurality of resources utilized in a service; calculating, based on the load information, a load distribution rate among the resources; determining, based on the load distribution, whether a load consolidation among the resources is necessary; detecting a first resource among the resources when the load consolidation is determined necessary at the determining; and allocating a load of the first resource to a second resource that is a destination resource, the destination resource being any resource among the resources other than the first resource.

A service load consolidating method according to another aspect of the present invention includes acquiring load information for each resource among a plurality of resources utilized in a service; calculating, based on the load information, a load distribution rate among the resources; determining, based on the load distribution, whether a load consolidation among the resources is necessary; detecting a first resource among the resources when the load consolidation is determined necessary at the determining; and allocating a load of the first resource to a second resource that is a destination resource, the destination resource being any resource among the resources other than the first resource.

A service load consolidating apparatus according to still another aspect of the present invention includes an acquiring unit that acquires load information for each resource among a plurality of resources utilized in a service; a first calculating unit that, based on the load information, calculates a load distribution rate among the resources; a determining unit that, based on the load distribution, determines whether a load consolidation among the resources is necessary; a detecting unit that detects a first resource among the resources when the load consolidation is determined necessary at the determining; and an allocating unit that allocates a load of the first resource to a second resource that is a destination resource, the destination resource being any resource among the resources other than the first resource.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a system configuration diagram of a resource accommodation system according to an embodiment of the present invention;

FIG. 2 is a hardware configuration diagram of a computer apparatus shown in FIG. 1;

FIG. 3 is a schematic illustrating storage contents of a load information database (DB);

FIG. 4 is a block diagram of a functional configuration of a load consolidating apparatus according to the embodiment;

FIGS. 5A and 5B are schematics outlining a process performed by the resource accommodation system according to the embodiment;

FIG. 6 is another schematic illustrating storage contents of the load information DB;

FIG. 7 is a schematic outlining a process of determining the necessity of the load consolidation; and

FIG. 8 is a flowchart of a load consolidation process performed by the load consolidating apparatus.

### DETAILED DESCRIPTION OF THE PREFERRED EMBODIMENTS

Referring to the accompanying drawings, exemplary embodiments according to the present invention are explained in detail below.

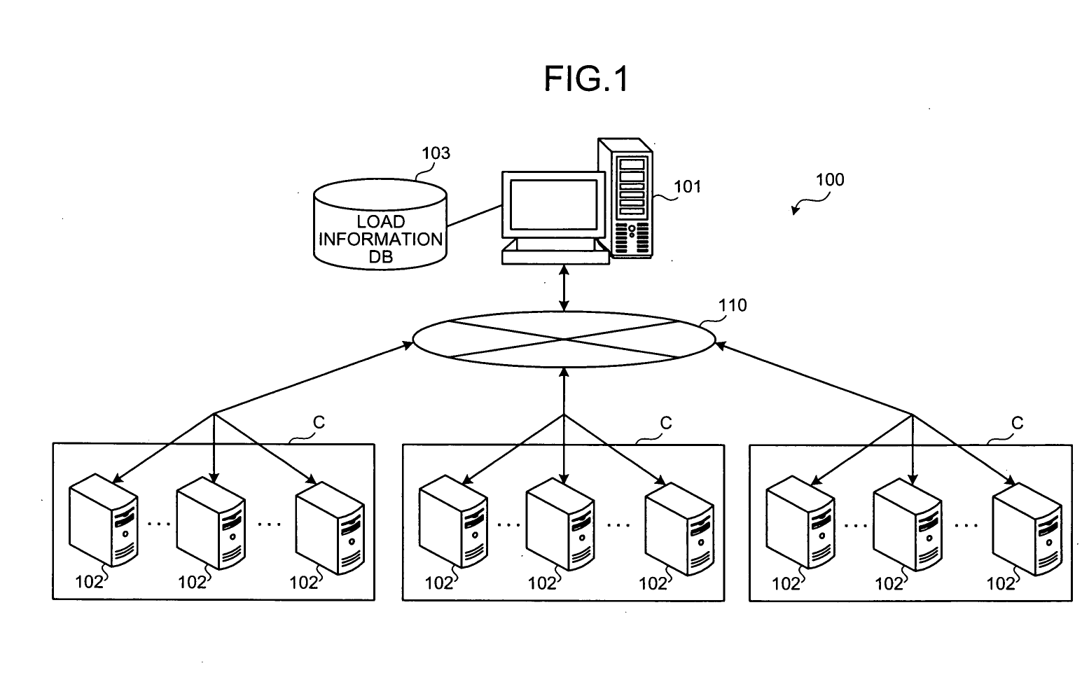

FIG. 1 is a system configuration diagram of a resource accommodation system 100 according to an embodiment of the present invention. As shown in FIG. 1, the resource accommodation system 100 includes a load consolidating apparatus 101 and resources 102 disposed on each site C, which are connected through a network 110.

The load consolidating apparatus 101 is a computer apparatus that performs brokering of the resources 102 utilized in services and that manages load allocation to each resource 102. The load consolidating apparatus 101 includes a load information DB 103 that stores load information of each resource 102.

Specifically, the load consolidating apparatus 101, according to a requested service, determines which resource 102 of which site C is to be allocated and also reallocates a resource 102 of a site C from one service to another service.

The load consolidating apparatus 101 manages the load allocated to each resource 102 utilized in a service based on the load information stored in the load information DB 103 for each resource 102. Specifically, the loads allocated to each of the resources 102 utilized in a service are properly adjusted to prevent excessive load distribution. The load information DB 103 is described in detail hereinafter.

The resource 102 is disposed at each site C and is a computer utilized for performing a task of service. Specifically, the resource 102 performs a task allocated by the load consolidating apparatus 101 for terminals (not shown).

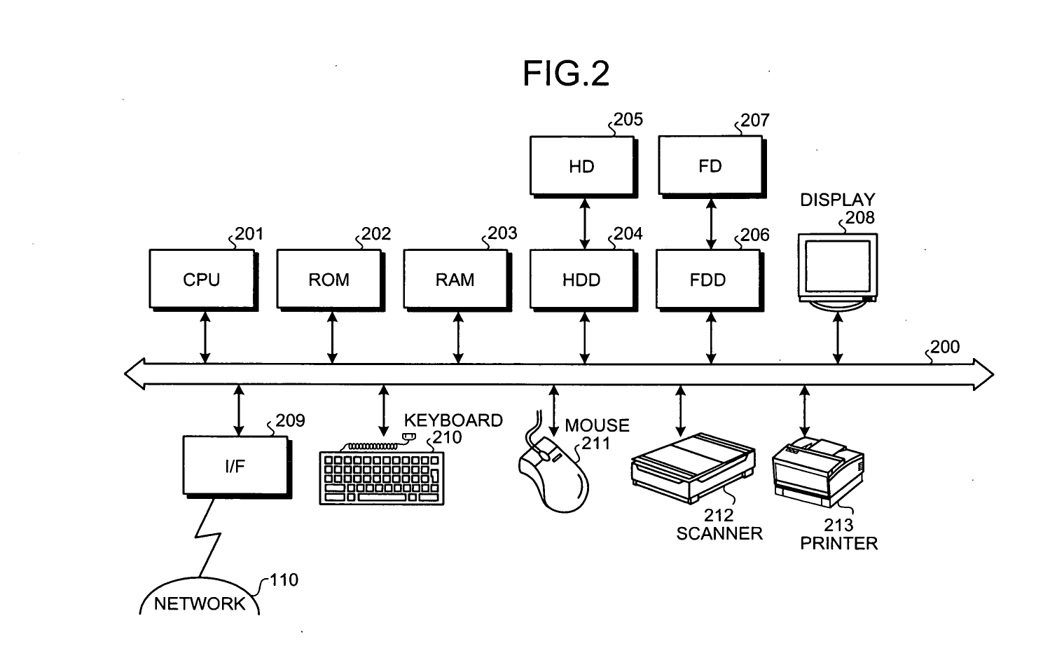

FIG. 2 is a hardware configuration diagram of the computer apparatus shown in FIG. 1. As shown in FIG. 2, the computer apparatus includes a central processing unit (CPU) 201, a read-only memory (ROM) 202, a random access memory (RAM) 203, a hard disk drive (HDD) 204, a hard disk (HD) 205, a flexible disk drive (FDD) 206, a flexible disk (FD) 207 as an example of a removable recording medium, a display 208, an interface (I/F) 209, a keyboard 210, a mouse 211, a scanner 212, and a printer 213. The constituent elements are connected to each other through a bus 200.

The CPU 201 is responsible for overall control of the computer apparatus. The ROM 202 stores programs such as a boot program. The RAM 203 is used as a work area of the CPU 201. The HDD 204 controls the reading and writing of data to and from the HD 205 under the control of the CPU 201. The HD 205 stores data written therein under the control of the HDD 204.

The FDD 206 controls the reading and writing of data to and from the FD 207 under the control of the CPU 201. The FD 207 stores data written therein under the control of the FDD 206 and allows the computer apparatus to read the data stored therein.

Other than the FD 207, the removable recording medium may be a compact disk read-only memory (CD-ROM) (compact disk-recordable (CD-R), a compact disk-rewritable (CD-RW)), a magneto optical disk (MO), a digital versatile disk (DVD), or a memory card. The display 208 displays a cursor, icons or tool boxes as well as data such as text, images, and function information. The display 208 may be, for example, a cathode ray tube (CRT), a thin-film-transistor (TFT) liquid crystal display, or a plasma display.

The I/F 209 is connected via a communication line to the network 110 such as the Internet and is connected to other apparatuses via this network 110. The I/F 209 is responsible for interfacing the network 110 with the inside of the apparatus and controls input and output of data to and from an external apparatus. The I/F 209 may be, for example, a modem or a local area network (LAN) adaptor.

The keyboard 210 for data entry is disposed with keys for entering characters, numeric characters, various instructions, etc. A touch-panel type input pad, a numeric keypad, etc., may be used instead. The mouse 211 moves a cursor, selects an area, or moves and resizes a window, etc. A trackball or joystick may be used instead, provided functions similar to a pointing device are included.

The scanner 212 optically reads an image and reads image data into the apparatus. The scanner 212 may have an optical character recognition (OCR) function. The printer 213 prints image data and text data. The printer 213 may be, for example, a laser printer or an ink-jet printer.

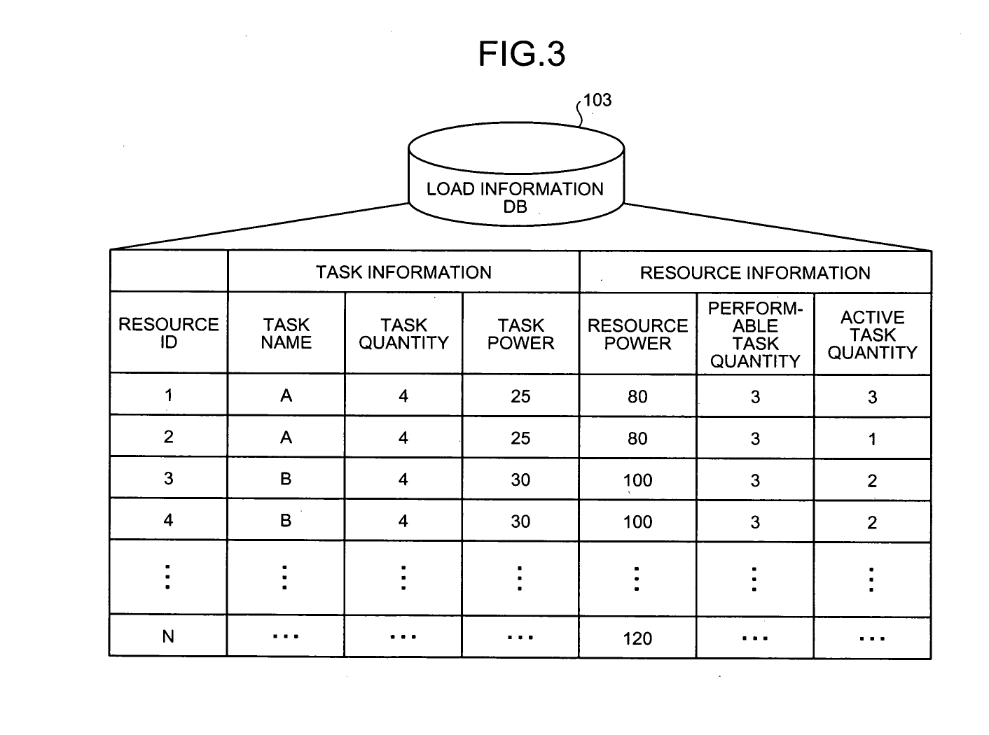

FIG. 3 is a schematic illustrating storage contents of a load information DB 103. As shown in FIG. 3, the load information DB 103 stores load information consisting of task information and resource information of each resource ID.

The resource ID, i (i=1 to N) is identification information that identifies a resource 102 among multiple resources 102 connected to the load consolidating apparatus 101 through the network 10. Each resource ID is correlated with the task information and the resource information.

The task information includes information related to a task of a service, e.g., task name, a task quantity, and a task power. The task name is a name of a task allocated to each resource 102. A task is information processing provided to a computer terminal of the resource 102 and includes, for example, non-interactive tasks such as a batch process of simulation jobs and interactive tasks such as Internet telephone and video conference systems.

The task quantity is the quantity of tasks required for each service. For example, to provide a video conference system linking five areas, the number of tasks must be at least five. The task power is an index that represents the processing power, such as CPU performance and a memory capacity, necessary for a resource 102 to perform one task.

The resource information includes information related to resource power, a performable task quantity, and an active task quantity. The resource power is an index that represents the processing power, such as CPU performance and a memory capacity, of each resource 102. The task power and the resource power are represented by a unified index.

The performable task quantity is the maximum number of tasks that can be concurrently performed in each resource 102. Specifically, for example, if the resource power of one resource 102 is “100” and the task power required for performing one task is “30”, the performable task quantity is “3”.

The active task quantity represents the number of tasks currently performed in each resource 102. Specifically, the load consolidating apparatus 101 allocates tasks to each resource 102 depending on the loads of requested services.

Taking as an example the resource 102 with the resource ID of 3 in the task information, the tasks performed for a utilized service have a task name of “service B”; the task quantity required for service B is 4; and the task power necessary for performing one task of service B is 30.

In the resource information, the resource power is 100; the quantity of concurrently performable tasks for service B is 3; and the number of currently performed tasks for service B is 2. Since the load information of each resource 102 dynamically changes over time, the storage contents of the load information DB 103 may be updated at regular time intervals.

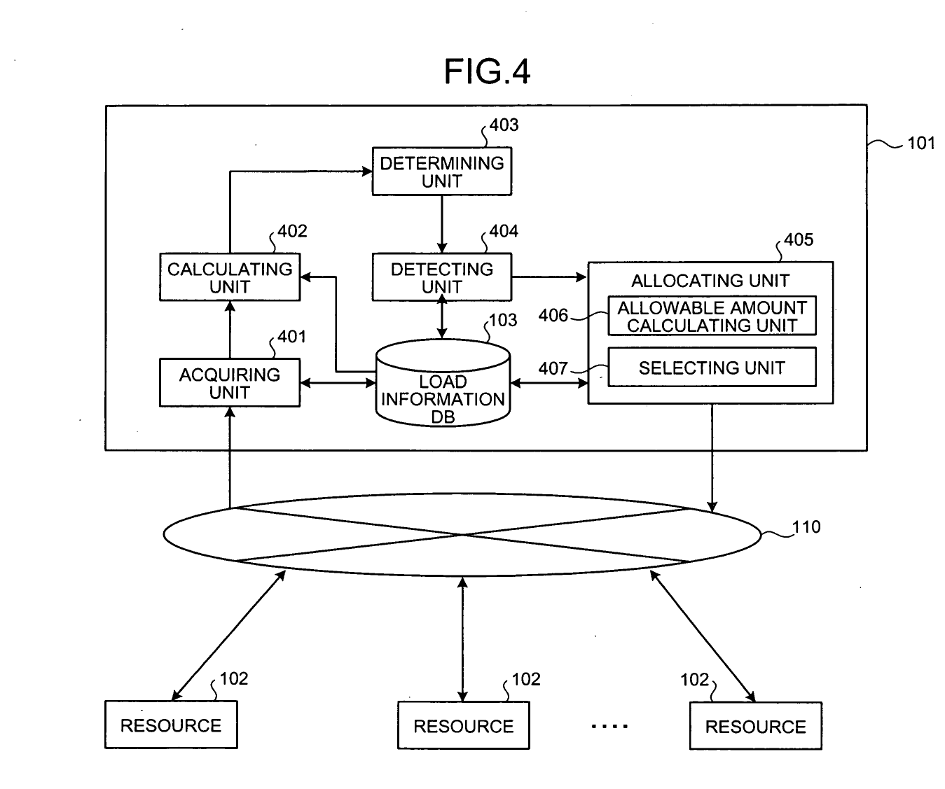

FIG. 4 is a block diagram of a functional configuration of the load consolidating apparatus 101 according to the embodiment of the present invention. As shown in FIG. 4, the load consolidating apparatus 101 includes the load information DB 103, an acquiring unit 401, a calculating unit 402, a determining unit 403, a detecting unit 404, and an allocating unit 405.

The acquiring unit 401 has a function of acquiring the load information of each resource 102 utilized in a service. The load is a unified index that represents a CPU usage rate, memory usage, and a network band utilization rate (traffic) of each resource 102 associated with the execution of the service.

The load information is information related to the load of the service allocated to each resource 102, such as the above task information, the resource information, etc., and is information that dynamically changes over time (see FIG. 3).

Specifically, the acquiring unit 401 may acquire the load information from each resource 102 through the network 110 or may acquire the load information from a computer apparatus that consolidates and provides information about a service, e.g., the load of each resource 102 utilized in the service and the status of allocation of the resources 102.

The load information acquired by the acquiring unit 401 is stored in the load information DB 103. Since the load information of each resource 102 dynamically changes over time, the load information is acquired at regular time intervals and is stored in the load information DB 103 in each case. The load information acquired by the acquiring unit 401 may be stored in a memory such as the RAM 203.

Specifically, the acquiring unit 401 may acquire the load information transmitted at regular preset time intervals. Alternatively, the acquiring unit 401 may request transmission of the load information from each resource 102 to acquire the load information.

The acquiring unit 401 may acquire only a dynamically changing portion (the task quantity, task power, etc.) of the load information stored in the load information DB 103. In this case, other static information (the resource power of each resource 102, etc.) may be preliminarily stored in the load information DB 103.

The calculating unit 402 has a function of calculating a load distribution rate among the resources utilized in a service based on the load information acquired by the acquiring unit 401. Specifically, the calculating unit 402 reads the load information of each resource 102 from the load information DB 103 and calculates a load distribution rate based on the load information with the use of a predetermined standard of value. The calculating unit 402 may read the load information stored in a memory such as the RAM 203 to calculate a load distribution rate based on the load information.

The load distribution rate is an index indicating how the load of the tasks concurrently performed is distributed and allocated to the resources 102 allocated to the service. The load distribution rate is represented relatively for the resources 102.

More specifically, as the load distribution rate, the number of resources 102 having a load smaller than a given value may be calculated. The given value can arbitrarily be set by direct input to the load consolidating apparatus 101 and is preliminarily set and stored in a memory such as the RAM 203.

For example, when the quotient obtained by dividing the “active task quantity” by the “performable task quantity” is smaller than the given value, the resource 102 having that value may be counted as a small load resource 102. That is, if the condition of “(active task quantity÷performable task quantity)<given value” is satisfied in any resource 102, the respective resource 102 is counted as a small load resource 102.

In this case, whether the above condition is satisfied may be determined for all the resources 102 allocated to the service or may be determined only for arbitrary resources 102. The specific process of calculating the number of small load resources 102 by the calculating unit 402 is described hereinafter.

An average load of the resources 102 utilized in the service may be calculated as the load distribution rate. The average load is an average of the load applied to the individual resources 102 when multiple tasks of the service are concurrently performed.

To obtain the average load, the “power necessary for one task” is multiplied by the “active task quantity”, and the product is divided by the “sum of resource power of all resources 102 allocated to service”. The specific process of calculating the average load by the calculating unit 402 will be described later. The calculation result of the calculating unit 402 is stored in a memory such as the RAM 203.

The determining unit 403 determines whether the loads distributed to each of the resources 120 are to be consolidated based on the calculation result of the calculating unit 402. Specifically, the determining unit 403 reads the calculation result stored in a memory such as the RAM 203 and determines based on the calculation result whether the loads are to be consolidated.

More specifically, if the calculating unit 402 calculates the number of the small load resources 102 as the load distribution rate, the determining unit 403 compares the calculation result with a given number N. If the number of the small load resources 102 is larger than the given number N, the determining unit 403 determines consolidation of the loads distributed to each of the resources 102 to be necessary.

The given number N that is compared with the number of the small load resources 102 calculated by the calculating unit 402 can arbitrarily be set by direct input to the load consolidating apparatus 101, and is preliminarily set and stored in a memory such as the RAM 203.

If the calculating unit 402 calculates the average load as the load distribution rate, the determining unit 403 compares the average load with a given value Z. If the average load becomes larger than the given value Z, the determining unit 403 determines consolidation of the loads distributed to each of the resources 102 to be necessary.

The given value Z that is compared with the average load calculated by the calculating unit 402 can arbitrarily be set by direct input to the load consolidating apparatus 101, and is preliminarily set and stored in a memory such as the RAM 203. The determination result of the determining unit 403 is stored in a memory such as the RAM 203.

The detecting unit 404 detects one resource 102 among the resources 102 utilized in a service if the determining unit 403 determines that the load of the service is to be consolidated. Specifically, the detecting unit 404 reads the determination result from the memory such as the RAM 203 and detects one resource 102 in accordance with the determination result.

More specifically, for example, based on the load information stored in the load information DB 103, the detecting unit 404 may detect an arbitrary resource 102 among the resources 102 utilized in the service. The detection result of the detecting unit 404 is stored in a memory such as the RAM 203.

The detecting unit 404 may detect the resource 102 having the smallest load among the resources 102 utilized in the service. More specifically, for example, the detecting unit 404 may detect the resource 102 having the smallest active task quantity or may calculate a load of each resource 102 from the task power and the active task quantity to detect the resource 102 having the smallest load.

The allocating unit 405 has a function of allocating the load of the resource 102 detected by the detecting unit 404 to another resource 102. Specifically, the allocating unit 405 reads the detection result stored in a memory such as the RAM 203 to allocate the load of one resource 102 to another resource 102.

More specifically, the allocating unit 405 transmits a task termination request to the resource 102 detected by the detecting unit 404 to terminate the task performed therein. To switch the resource 102 utilized for the task to another resource 102, the allocating unit 405 transmits a load allocation request to another resource 102.

If multiple tasks are performed in the resource 102 detected by the detecting unit 404, the load of all the tasks may be allocated entirely to another resource 102 singularly, or may be allocated separately, in which case an allocation recipient resource 102 for each task load is determined.

When the load of one resource 102 is allocated to another resource 102, various instructions may be transmitted to a computer apparatus that collects and provides information about each task. In this case, the instructions related to the allocation of the load are transmitted from the computer apparatus to each resource 102.

The allocating unit 405 may have a function of allocating the load of one resource 102 detected by the detecting unit 404 to another resource 102 allocated with a load equal to or larger than the load of the detected resource 102.

Specifically, the allocating unit 405 may read the load information stored in the load information DB 103 and may retrieve another resource 102 allocated with a load equal to or larger than the load of the resource 102 detected by the detecting unit 404 and allocate the load of the detected resource 102 to the retrieved resource 102.

As a result, the load of the detected resource 102 can be allocated to another resource 102 to prevent further distribution of the load, and the load of the service can efficiently be consolidated.

The allocating unit 405 may include an allowable amount calculating unit 406 and a selecting unit 407. The allowable amount calculating unit 406 has a function of calculating an allowable amount of a load that can be received by another resource 102, i.e., an available load capacity. The allowable amount of load, for example, is an index representing a load that can be allocated to another resource 102 and is an available memory capacity of each resource 102.

Specifically, for example, the allowable amount calculating unit 406 reads the load information stored in the load information DB 103 to calculate each allowable amount of load that can be allocated to other resources 102. The allowable amounts of load of the resources 102 calculated by the allowable amount calculating unit 406 are stored in a memory such as the RAM 203.

The selecting unit 407 selects the resource 102 having an allowable amount conforming to the load of the resource 102 detected by the detecting unit 404, by comparing the allowable amounts calculated by the allowable amount calculating unit 406 with the load of the detected resource 102. The resource 102 having an allowable amount conforming to the load of the detected resource 102 is the resource 102 to which the load of the detected resource 102 can be allocated and which has the smallest allowable amount of among the resources 102.

Specifically, the selecting unit 407 reads the allowable amounts of load of the resources 102 stored in a memory such as the RAM 203 and compares the allowable amounts with the load of the detected resource 102. The selecting unit 407 then selects, from among the resources 102, the resource 102 having an allowable amount conforming to the load of the detected resource 102.

As a result, a service can be performed taking full advantage of the processing power of individual resources 102, and the load of the service can efficiently be consolidated.

When receiving a request from another service, the load consolidating apparatus 101 may have a function of causing the resource 102 whose load has been allocated to another resource 102 by the allocating unit 405 to be utilized in another service.

As a result, the time required for changing the utilization of a particular resource 102 between different services can be reduced and resource accommodation can efficiently be performed.

With regard to the acquiring unit 401, the calculating unit 402, the determining unit 403, the detecting unit 404, and the allocating unit 405, specifically, for example, the functions thereof are realized by the CPU 101 executing programs recorded in a recording medium such as the ROM 202, the RAM 203, and the HD 205 shown in FIG. 1, or by the I/F 209.

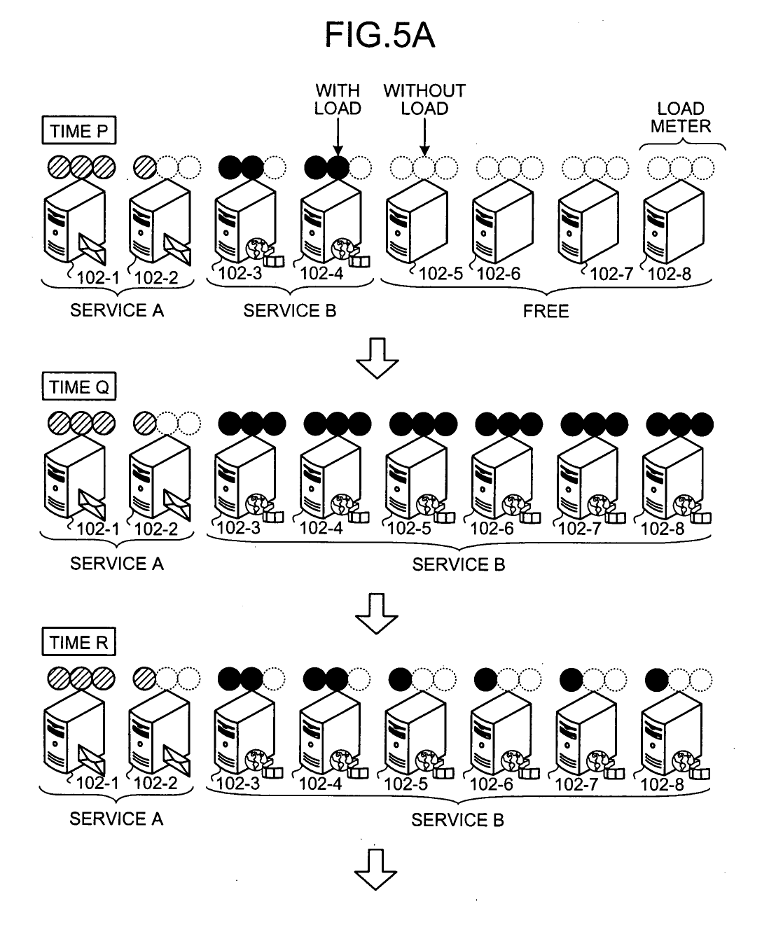

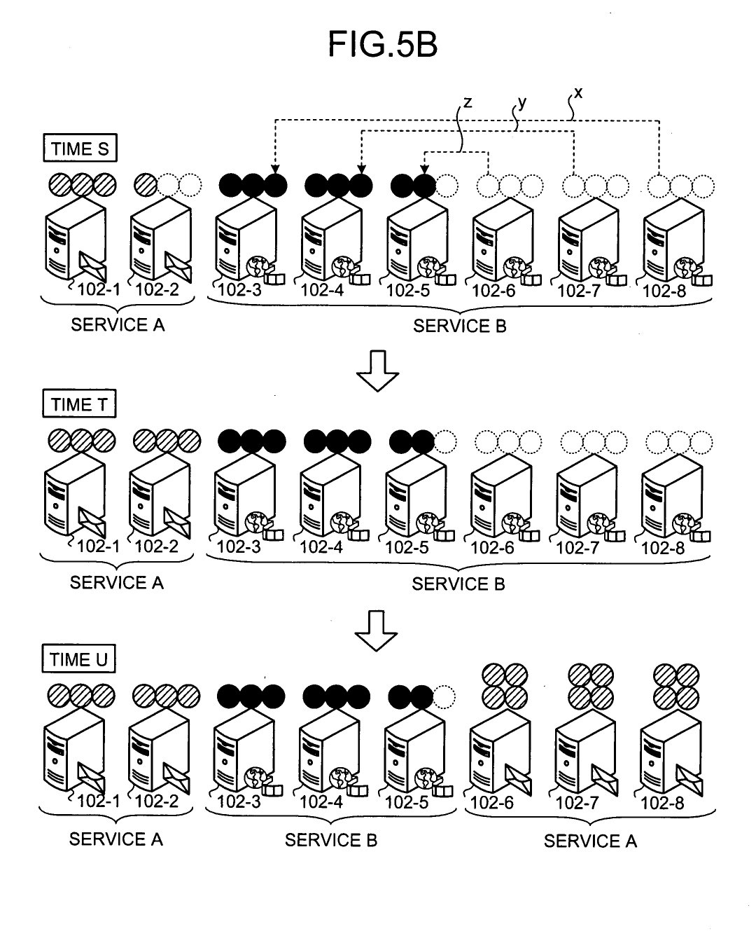

FIGS. 5A and 5B are schematics outlining a process of the resource accommodation system 100 according to the embodiment of the present invention.

Description will be made of a case in which multiple resources 102 are utilized in a batch process (“service A” of FIGS. 5A and 5B) and a video conference system (“service B” of FIGS. 5A and 5B) of a company. In FIGS. 5A and 5B, times P to T indicate clock times, and the time elapses in the order of time P, time Q, time R, time S, time T, and time U.

Circles (hereinafter, “load meters”) shown in FIGS. 5A and 5B represent loads of tasks allocatable to the resources 102, i.e., the number of tasks executable in the resources 102. Load is indicated in the load meter by hatching or a solid black color. If there is no load, the load meter is solid white.

The resource power of resources 102-1 and 102-2 is assumed to be “80” and the resource power of resources 102-3 to 102-8 is assumed as “100”. The task power of a task in service A is assumed to be “25” and the task power of a task in service B is assumed as “30”.

At the time P shown in FIG. 5A, the resource 102-1 and the resource 102-2 are utilized in service A. Specifically, the task quantity of service A is “4”, among which the task quantity allocated to the resource 102-1 is “3” and the task quantity allocated to the resource 102-2 is “1”.

The resource 102-3 and the resource 102-4 are utilized in service B. Specifically, the task quantity of a task in the service B is “4”, among which the task quantity allocated to the resource 102-3 is “2” and the task quantity allocated to the resource 102-4 is “2”.

The resources 102-5 to 102-8 are not utilized in any service and all the load meters are blank. The resources 120 not utilized in any service (the resources 102-5 to 102-8 in this case) are designated as “free”.

At the time Q shown in FIG. 5A, due to an increase in the video conference system users, the load of service B increase, and the free resources 102-5 to 102-8 are utilized in service B. Specifically, since the task quantity for service B has increased from “4” to “18”, the task quantity allocated to the resources 102-3 to 102-8 becomes “3”.

At the time R of FIG. 5A, due to a decrease in the video conference system users, the load of service B has decreased. In this situation, a load distribution rate is calculated among the resources 102 utilized in service B, and if the load of service B is excessively distributed, the load is consolidated.

This measure is executed in this situation because the currently active tasks for service B must be terminated in the resources 102-3 to 102-8 to accommodate another service (e.g., service A), which requires time.

Therefore, in anticipation of a resource accommodation request from another service, the loads of the resources 102-3 to 102-8 are consolidated to reduce the time required for the resource accommodation. Details of the specific process of determining the necessity of the load consolidation will be described.

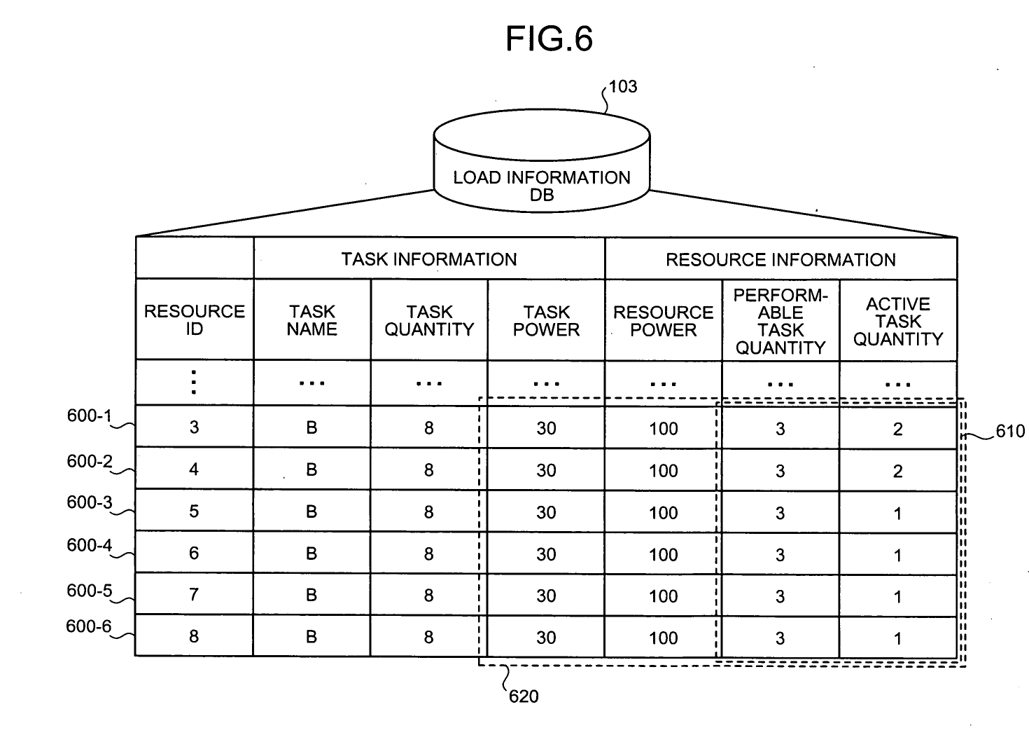

FIG. 6 is an explanatory view (No. 2) of the storage contents of the load information DB 103. FIG. 6 depicts load information 600-1 to 600-6 of the resources 102-3 to 102-8 utilized in service B at the time R of FIG. 5A. The load information 600-1 to 600-6 is used to calculate the load distribution rate of service B.

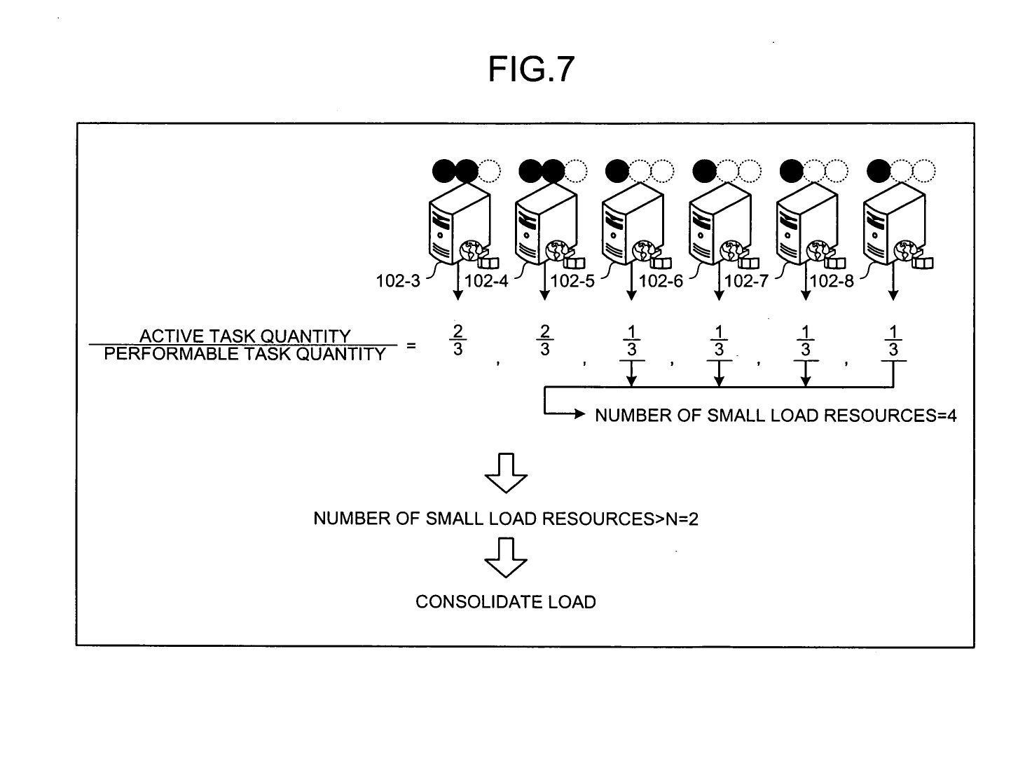

A case is described in which the number of resources 102 having a load smaller than a given value is calculated among the resources 102-3 to 102-8 as the load distribution rate. FIG. 7 is a diagram outlining the process of determining the necessity of the load consolidation.

As shown in FIG. 7, “active task quantity÷performable task quantity” is calculated based on the “performable task quantity” and the “active task quantity” shown in a dotted frame 610 of FIG. 6. The resources 102 having a calculated result smaller than a given value P are counted as the small load resources 102.

Here, the given value P is assumed to be “P=0.5”, i.e., the small load resource 102 is defined as a resource 102 having at least half of its processing power available for allocation of additional service B loads.

Specifically, the resource 102-3 is not counted as the small load resource 102 because of “active task quantity÷performable task quantity=⅔>P”. The resource 102-4 is not counted as the small load resource 102 because the “active task quantity-performable task quantity=⅔>P”.

The resource 102-5 is counted as the small load resource 102 because the “active task quantity÷performable task quantity=⅓<P”. Similarly, “active task quantity÷performable task quantity” is calculated for the resources 102-5 to 102-8, and the resources 102 having a calculation result smaller than the given value P are counted. As a result, the resources 102 with “active task quantity÷performable task quantity<P” include four resources 102-5, 102-6, 102-7, and 102-8.

If the number of the small load resources 102, i.e., the number of resources 102 with “active task quantity÷performable task quantity<P” is greater than a given number N, the loads are determined to be excessively distributed, requiring consolidation.

Assuming that the given value N is “N=2”, since the number of resources 102 with “active task quantity÷performable task quantity<P” is “4” and the “number of the small load resources 102>N=4”, the loads are determined to be excessively distributed, requiring consolidation.

A case is described in which an average load of the resources 102-3 to 102-8 utilized in service B is calculated as the load distribution rate. The average load of the resources 102-3 to 102-8 is calculated by the following equation (1).

average load=(task power of service B×task quantity of service B)+(sum of resource power of resources 102-3 to 102-8 utilized in service B) (1)

Specifically, the “task power”, “resource power”, and “active task power” shown in a dotted frame 620 of FIG. 6 are substituted in the above equation (1) to calculate the average load of the resources 102-3 to 102-8. More specifically, the above equation will be

(1)=(30×8)÷(100×6)=240÷600=⅖.

If the average load is greater than the given value Z, the load of service B is determined to be excessively distributed, requiring consolidation. Assuming that the given value Z is “Z=½”, because the “average load=⅖” and the “average load<Z”, the load of service B is determined to be excessively distributed, requiring consolidation.

At the time S shown in FIG. 5B, the load of service B distributed to the resources 102-3 to 102-8 are consolidated. Specifically, the load of service B distributed to the resources 102-3 to 102-8 are consolidated to the resources 102-3 to 102-5.

More specifically, the load of the resource 102-8 is allocated to the resource 102-3 (arrow x shown in FIG. 5B); the load of the resource 102-7 is allocated to the resource 102-4 (arrow y shown in FIG. 5B); and the load of the resource 102-6 is allocated to the resource 102-5 (arrow z shown in FIG. 5B).

Describing the load allocation procedure in this case, the resource 102-8 having the smallest load is detected among the resources 102-3 to 102-8, and the load thereof is allocated to the resource 102-3, which already has a load equal to or larger than the load of the resource 102-8 (arrow x shown in FIG. 5B).

The resource 102-7 having the smallest load is detected among the resources 102-3 to 102-7, and the load thereof is allocated to the resource 102-4, which already has a load equal to or larger than the load of the resource 102-7 (arrow y shown in FIG. 5B).

Finally, the resource 102-6 having the smallest load is detected among the resources 102-3 to 102-6, and the load thereof is allocated to the resource 102-5, which already has a load equal to or larger than the load of the resource 102-7 (arrow z shown in FIG. 5B).

In this way, the temporal cost is reduced when allocating the loads and the loads of service B can efficiently be consolidated. As a result, although allocated to service B, the resources 102-6 to 102-8 have no load, and resource accommodation can efficiently be performed for other services.

At the time S of FIG. 5B, since users of the batch process increase for sales calculations and order calculations, the load of service A increases. Although allocated to service B, the resources 102-6 to 102-8 have no load, i.e., are not utilized in service B.

At the time U shown in FIG. 5B, the resources 102-6 to 102-8 initially allocated to service B are allocated and utilized for service A. Since the resources 102-6 to 102-8 initially allocated to service B have no load, the time required for changing the allocation of the resources 102-6 to 102-8 from utilization in service B to service A is reduced and resource accommodation can be efficiently performed.

By consolidating a portion of the loads of the tasks in the resources 120 in anticipation of resource accommodation between different services, efficient resource accommodation can be achieved to realize smooth provision of services respectively.

Although the resources 102-6 to 102-8 are allocated to service A after the task of service B performed in the resources 102-6 to 102-8 are completely terminated at the time S shown in FIG. 5B, the resources 102-6 to 102-8 may be allocated to service A as the loads of service B are eliminated.

That is, the resources 102-6 to 102-8 may be allocated to service A as each of the tasks for service B are completed. As a result, resource accommodation can efficiently be performed regardless of relative time differences in the termination of tasks for service B among the resources 102-6 to 102-8.

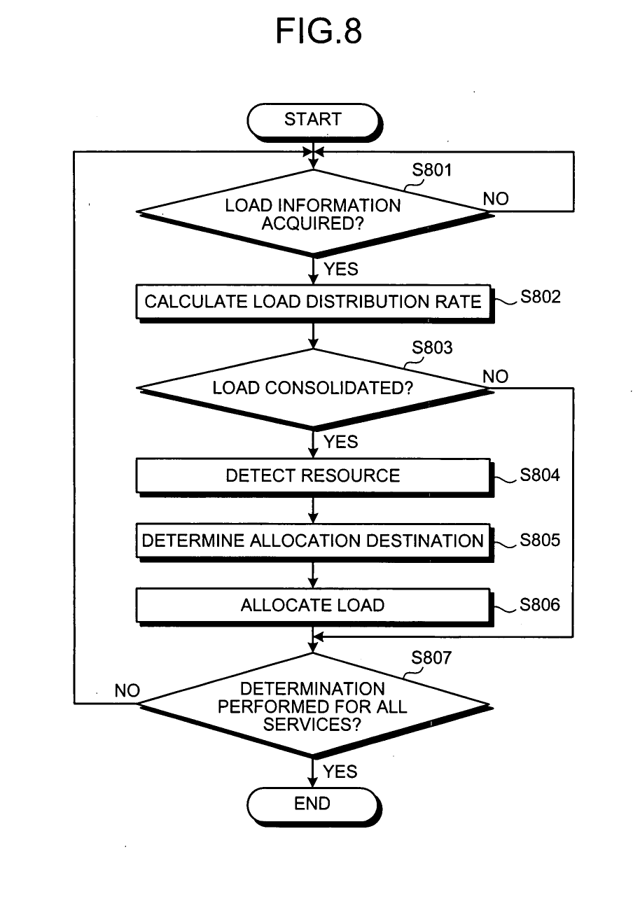

FIG. 8 is a flowchart of a load consolidation process of the load consolidating apparatus 101 according to the embodiment of the present invention. As shown in FIG. 8, whether the acquiring unit 401 acquires the load information of each resource 102 utilized in a service is judged (step S801).

After waiting for the load information (step S801: NO), if the load information is acquired (step S801: YES), the calculating unit 402 calculates the load distribution rate among the resources 102 utilized in the service based on the load information acquired by the acquiring unit 401 (step S802).

The determining unit 403 determines based on the calculation result of the calculating unit 402 whether the loads distributed to each of the resources 102 are to be consolidated (step S803). If it is determined that the loads are to be consolidated (step S803: YES), the detecting unit 404, among the resources 102 utilized in the service, detects one resource 102 whose load is to be allocated (S804).

Another resource 102 is determined as an allocation destination of the load of the detected resource 102 (step S805), and the allocating unit 405 allocates the load of the detected resource 102 to the other resource 102 determined as the allocation destination (step S806). It is then judged whether the necessity of load consolidation has been determined for all the active services (step S807).

If it is judged that determining the necessity of load consolidation has been performed for each of the services (step S807: YES), the series of processes shown in the flowchart is terminated. On the other hand, if it is judged that determining the necessity of load consolidation has not been performed for each of the services (step S807: NO), the procedure goes back to step S801 and repeats the series of processes.

If it is determined that the load of the service is not to be consolidated at step S803 (step S803: NO), the procedure goes to step S807.

According to the embodiment of the present invention, by consolidating a portion of the loads of the service in some resources 120 in anticipation of resource accommodation between different services, efficient resource accommodation can be achieved to realize smooth provision of individual services.

At step S804, the detecting unit 404 may detect the resource 102 having the smallest load among the resources 102 utilized in the service.

As a result, the time required for allocating the load of the detected resource 102 to another resource 102 can be reduced, and the load of the service can efficiently be consolidated.

At step S805, the allocation destination of the load of the resource 102 detected by the detecting unit 404 may be another resource 102 having a load equal to or larger than the load of the detected resource 102.

As a result, the load of one resource 102 can be allocated to another resource 102 to prevent further distribution of the load of the service, and the load of the service can be efficiently consolidated.

At step S805, the allowable amount calculating unit 406 may calculate an allowable amount of load allocatable to another resource 102 and the selecting unit 407 may compare the allowable amounts calculated by the allowable amount calculating unit 406 with the load of the resource 102 detected by the detecting unit 404 to decide the allocation destination thereof among other resources 102, in which the resource having an allowable amount conforming to the load of the detected resource 102 is decided as the allocation destination.

As a result, a service can be performed taking full advantage of the processing power of individual resources 102, and the load of the service can efficiently be consolidated.

As described above, according to the load consolidating program, the recording medium recording the program, the load consolidating apparatus, and the load consolidating method, efficient resource accommodation can be achieved to realize smooth provision of individual services.

The load consolidating method described in the embodiment can be realized by executing a program prepared in advance with a computer such as a personal computer or a workstation. The program is recorded on a computer-readable medium such as a hard disk, flexible disk, CD-ROM, MO, and DVD and is read from the recording medium by the computer for execution. The program may be a transmission medium distributable through a network such as the Internet.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A computer-readable recording medium storing therein a computer program that causes a computer to execute:
acquiring load information for each resource among a plurality of resources utilized in a service;
calculating, based on the load information, a load distribution rate among the resources;
determining, based on the load distribution, whether a load consolidation among the resources is necessary;
detecting a first resource among the resources when the load consolidation is determined necessary at the determining; and
allocating a load of the first resource to a second resource that is a destination resource, the destination resource being any resource among the resources other than the first resource.

2. The computer-readable recording medium according to claim 1, wherein
the calculating includes calculating, among the resources, a quantity of resources having a load smaller than a given value.

3. The computer-readable recording medium according to claim 1, wherein
the calculating includes calculating an average load of the resources.

4. The computer-readable recording medium according to claim 1, wherein
the first resource is a resource having the smallest load among the resources.

5. The computer-readable recording medium according to claim 1, wherein
the second resource is any destination resource having a load equal to or larger than the load of the first resource.

6. The computer-readable recording medium according to claim 1, wherein the computer program further causes the computer to execute:
calculating an available load capacity of the resources; and
selecting the second resource that has a suitable available load capacity for the load of the first resource by comparing the available load capacity with the load of the first resource.

7. A service load consolidating method comprising:
acquiring load information for each resource among a plurality of resources utilized in a service;
calculating, based on the load information, a load distribution rate among the resources;
determining, based on the load distribution, whether a load consolidation among the resources is necessary;
detecting a first resource among the resources when the load consolidation is determined necessary at the determining; and
allocating a load of the first resource to a second resource that is a destination resource, the destination resource being any resource among the resources other than the first resource.

8. The service load consolidating method according to claim 7, wherein
the calculating includes calculating, among the resources, a quantity of resources having a load smaller than a given value.

9. The service load consolidating method according to claim 7, wherein
the calculating includes calculating an average load of the resources.

10. The service load consolidating method according to claim 7, wherein
the first resource is a resource having the smallest load among the resources.

11. The service load consolidating method according to claim 7, wherein
the second resource is any destination resource having a load equal to or larger than the load of the first resource.

12. The service load consolidating method according to claim 7, wherein the computer program further causes the computer to execute:
calculating an available load capacity of the resources; and
selecting the second resource that has a suitable available load capacity for the load of the first resource by comparing the available load capacity with the load of the first resource.

13. A service load consolidating apparatus comprising:
an acquiring unit that acquires load information for each resource among a plurality of resources utilized in a service;
a first calculating unit that, based on the load information, calculates a load distribution rate among the resources;
a determining unit that, based on the load distribution, determines whether a load consolidation among the resources is necessary;
a detecting unit that detects a first resource among the resources when the load consolidation is determined necessary at the determining; and
an allocating unit that allocates a load of the first resource to a second resource that is a destination resource, the destination resource being any resource among the resources other than the first resource.

14. The service load consolidating apparatus according to claim 13, wherein
the first calculating unit further calculates, among the resources, a quantity of resources having a load smaller than a given value.

15. The service load consolidating apparatus according to claim 13, wherein
the first calculating unit further calculates an average load of the resources.

16. The service load consolidating apparatus according to claim 13, wherein
the first resource has the smallest load among the resources.

17. The service load consolidating apparatus according to claim 13, wherein
the second resource is any destination resource having a load equal to or larger than the load of the first resource.

18. The service load consolidating apparatus according to claim 13, wherein the allocating unit includes:
a second calculating unit that calculates an available load capacity of the resources; and
a selecting unit that selects the second resource that has a suitable available load capacity for the load of the first resource by comparing the available load capacity with the load of the first resource.
